(19) United States
(12) Patent Application Publication
(10) Pub. No.: US 2008/0236501 A1
(43) Pub. Date: Oct. 2, 2008

(54) Pet bed cover

(76) Inventors: Heather Leigh Hargrave, Saluda, NC (US); Gerald Burk Hargrave, Saluda, NC (US)

Correspondence Address: James C. Edwards, 1408 Home Place, Matthews, NC, 28105, US

(21) Appl. No.: 11/729,639

(22) Filed: Mar. 29, 2007

(51) Int. Cl. A01K 1/035

(52) U.S. Cl. 119/28.5

(57) ABSTRACT

A pet bed cover is presented that is especially suited to accommodate an infant mattress. As such, the pet bed cover provides for an environmentally friendly pet bed, in that, the user is able to convert an infant mattress into a pet bed to thereby extend the useful life of the infant mattress. Additionally, the user is provided an inexpensive option for a pet bed because the user only has to purchase the additional pet bed cover in order to create a highly durable, attractive and comfortable pet bed.

### BACKGROUND

1. Field

The disclosed aspects relate to pet accessories and, more particularly, to a pet bed cover having dimensions suited to accommodate a conventional infant mattress.

2. Background

Unquestionably, pets continue to grow in popularity in the United States. In 1988, 56% of surveyed homes owned a pet, while today that number has risen to 63%, which equates to more than 69 million homes. The growth in pet popularity has characteristically led to marked growth in the pet industry. According to American Pet Products Manufacturing Association, Inc. (APPMA), in 1988 United States pet industry expenditures were approximately $23 million, while in 2006 the amount rose to approximately $38.5 million and the 2007 estimated amount stands at approximately $40.8 million. This upward trend in pet expenditures leads to the conclusion that pet owners are willing to spend to keep their pets healthy, happy and comfortable.

Pet beds, such as dog beds or cat beds, have become increasingly popular. Some pet owners frown upon having a pet sleep or rest on furniture, such as chairs, couches, conventional beds and the like, thus, the pet bed provides an ideal alternative means for pets to sleep or otherwise lounge. It is not uncommon in many pet-owning households to have multiple pet beds located throughout the home or in the home's yard to accommodate the transitory nature of the pet.

Pet owners, like society in general, are becoming increasingly more concerned with protecting the environment. In this regard, some pet owner may be more drawn to pet products that are environmentally safe or aid in protecting the environment, such as products made from recycled materials, products that do not adversely effect the environment during use or products that are biodegradable after their useful life has been expended. Additionally, while pet owners have shown a willingness to spend money of their pets, consumers in general, pet owners or otherwise, have always been prudent in making purchases that are economical, especially when it comes to non-essential purchases, such as pet products.

Conventional mattresses suited for a human bed have continually posed an environmental problem in terms of the ability to dispose of the mattress after normal use. In most instances, mattresses are constructed of synthetic materials that are not biodegradable and, thus, after the consumer has worn out the mattress the only option is to dispose of the mattress by conventional means. The infant mattress, such as a baby crib mattress, poses a unique problem in terms of disposal because typically the infant mattress is used for only a short period of time (for example, 1-3 years) before a child outgrows the crib and moves to a conventional bed. Thus, after the typical use-period, the infant mattress still remains in a useable condition. However, if the user has no other plans for additional children to use the mattress, the personal nature of the infant mattress often poses problems in terms of selling the used infant mattress or passing the used infant mattress on to friends or family. Ultimately, many infant mattresses meet the same fate as conventional mattress, that is, disposal in a landfill area.

Thus, a need exists to develop a pet bed that is environmentally friendly and economical. Additionally, a need exists to develop an alternative use for infant mattresses such that the useful life of the mattress may be extended by converting the mattress into an alternative product.

### SUMMARY

Present embodiments of the invention provide for a pet bed cover having dimensions suited to accommodate a conventional infant mattress. The pet bed cover of the present invention allows for the user to recycle an infant mattress into a pet bed after the infant has outgrown the use of the mattress. As such, the pet bed cover of the present invention is economically friendly, in that, it extends the useful life of the infant mattress. Additionally, the pet bed cover of the present invention provides for an inexpensive pet bed because the user only has to purchase the pet bed cover and otherwise relies on a preexisting infant mattress to form the pet bed. The resulting pet bed is highly durable and provides required comfort to the pet.

According to an embodiment of the present invention, a pet bed cover is defined. The pet bed cover includes a first bed top panel, a second bed top panel and at least one side panel affixed to the first and second bed top panels. The pet bed cover further includes an opening formed in either a side panel, a bed top panel or a side panel-to-bed top panel interface and a mattress-receiving compartment in communication with the opening and formed by interior surfaces of the first and second bed panel and the at least one side panel. The e mattress-receiving compartment is dimensionally configured to receive an infant mattress.

In one embodiment of the invention, the mattress-receiving compartment has a length greater than about 52 inches, a width of greater than about 27 inches and a depth of greater than about 6. In one embodiment of the invention, the mattress-receiving compartment has a preferable length in the range of 50 inches to about 60 inches, a preferable width in the range of about 25 inches to about 32 inches and a preferable depth of about 3 inches to about 10 inches. In one specific embodiment, the mattress-receiving compartment has a length in the range of about 52 inches to about 55 inches, a width in the range of about 28 inches to about 30 inches and a depth of about 6 inches to about 8 inches, suitable to house a conventional 5.5 inches thick infant mattress. In another specific embodiment, the mattress compartment has a length in the range of about 52 inches to about 55 inches, a width in the range of about 28 inches to about 30 inches and a depth of about 3 inches to about 5 inches, suitable to house a conventional 2.5 inches thick infant mattress.

The first and second bed top panels include an exterior surface that may be formed from any material suitable for a pet bed. For example, the first and second bed top panels may be formed from a natural fleece, a synthetic fleece, a natural twilled fabric, a synthetic twilled fabric, a natural quilted fabric, and a synthetic quilted fabric. The side panels may be formed from the same material as the bed top panels or the side panels may be formed from another suitable material. Additionally, the pet bed cover typically includes an enclosure mechanism associated with the opening that serves to close the opening when the infant mattress is placed in the mattress-receiving compartment. The enclosure mechanism may include, but is not limited to, a zipper, a hook and loop fabric fastener, a plurality of buttons, a plurality of metallic snap fasteners and the like.

Thus, the present invention provides for a pet bed cover that allows for an infant mattress to be converted into a pet bed. As such, the present invention is environmentally friendly, in that, the useful life of an infant mattress is extended beyond its intended purpose. The pet bed cover of the present invention also provides for a cost efficient pet bed because the consumer only needs to invest in the inexpensive pet bed cover in order to be afforded a high quality pet bed.

### BRIEF DESCRIPTION OF THE DRAWINGS

The disclosed aspects will hereinafter be described in conjunction with the appended drawings, provided to illustrate and not to limit the disclosed aspects, wherein like designations denote the elements, and in which:

FIG. 1 is a perspective view diagram of the components for a pet bed cover, according to embodiment of the present invention; and

FIG. 2 is a perspective view diagram of a pet bed cover, according to an embodiment of the present invention.

### DETAILED DESCRIPTION

The present embodiments of the invention now will be described more fully hereinafter with reference to the accompanying drawings, in which aspects of the invention are shown. The present embodiments of the invention may, however, be embodied in many different forms and should not be construed as limited to the aspects set forth herein; rather, these aspects are provided so that this disclosure will be thorough and complete, and will fully convey the scope of the invention to those skilled in the art. Like numbers refer to like elements throughout.

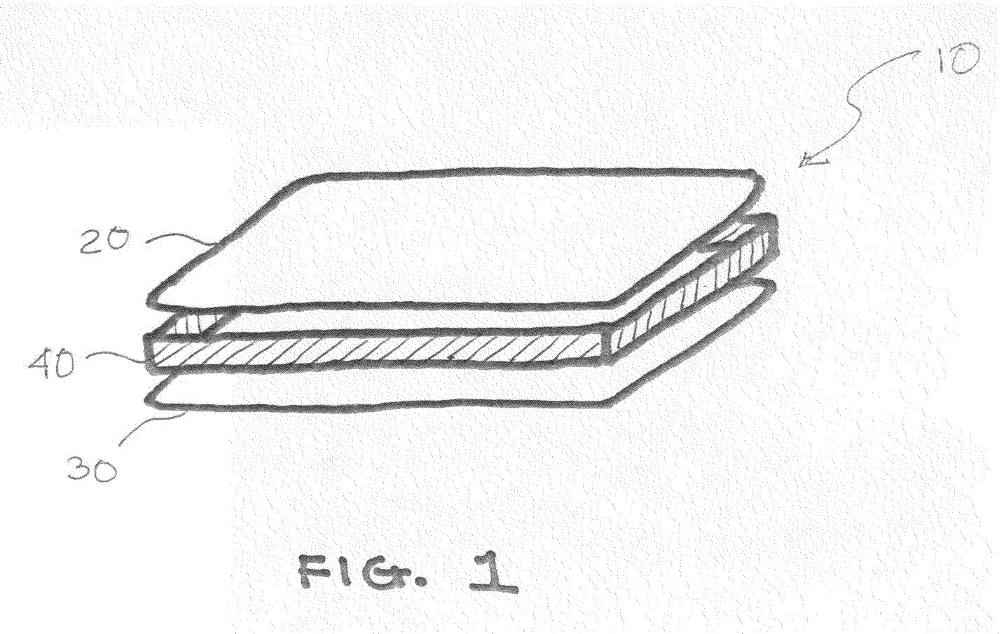

FIG. 1 provides a perspective view of the components of a pet bed cover, according to the present invention. It should be noted that while the pet bed cover of the present invention is especially well suited for a dog it may also be used for cats or any other domesticated animal. The pet bed cover 10 includes a first bed top panel 20, a second bed top panel 30 and a side panel 40. The first and second bed top panels 20 and 30 are generally rectangular in shape and formed of a material or fabric suitable for a pet bed top. The generally rectangular shaped bed top panels are dimensionally configured to allow for an infant mattress to be securely housed within the resulting pet bed cover. Conventional infant mattresses are similarly sized to accommodate generic sizing of infant cribs. A standard sized infant mattress typically has a length of about 52 inches, a width of about 28 inches and a depth of either 2.5 inches or 5.5 inches. The depth of the infant mattress typically equates to the quality of the mattress, with the thicker mattress being more durable and of higher quality. Therefore, according to the present invention, the bed top panels will have a length slightly greater than 52 inches and a width slightly greater than 28 inches.

The first and second bed top panels 20 and 30 may be a single layer construct or the bed top panels may be a multilayer construct. In the single layer construct or in a multilayer construct, the exterior surface of the bed top panels may be formed from a natural fleece, a synthetic fleece, a natural twilled fabric, a synthetic twilled fabric, a natural quilted fabric and a synthetic quilted fabric or any other suitable material or fabric. In certain aspects, the bed top panels may be formed from a fabric or material suitable to be or treated to be machine-washable, fire-resistant and/or water-resistant or water-repelling.

The side panel 40 of the FIG. 1 embodiment is one continuous side panel that is subsequently affixed to the periphery of all four sides of the first and second bed top panels 20 and 30. In alternate embodiments, more than one side panel 40 may be employed, such that each side panel is subsequently affixed to the periphery of one or more sides of the first and second bed top panels. In one specific embodiment, four side panels may be employed, with each side panel being subsequently affixed to the periphery of each corresponding side of the first and second bed top panels 20 and 30. In such an embodiment, the four side panels are affixed to each other proximate the four corners of the pet bed. Similar to the bed top panels, the side panels will are dimensionally configured to allow for an infant mattress to be securely housed within the resulting pet bed cover. Since conventional infant mattresses have a depth of about 2.5 inches or about 5.5 inches, the side panels will characteristically have a depth of slightly greater than about 2.5 inches or about 5.5 inches depending on which infant mattress the pet bed cover is configured to accommodate. Additionally, for the embodiment of the invention that provides for a single side panel 40, the length of the side panel will typically be slightly greater than about 160 inches to accommodate the perimeter dimensions of a 52×28 inch conventional infant mattress. In those embodiments in which more than one side panel are employed, the cumulative length of the side panels will typically be slightly greater than about 160 inches.

The side panel 40 may be formed from a similar material or fabric as the bed top panels 20 and 30 or the side panel may be formed of a different material or fabric. For example, the side panel 40 may be formed from a natural twilled fabric, a synthetic twilled fabric, a natural fleece, a synthetic fleece, or any other suitable material or fabric. Similar to the bed top panels, in certain aspects, the side panel(s) may be formed from a fabric or material suitable to be or treated to be machine-washable, fire-resistant and/or water-resistant or water-repelling.

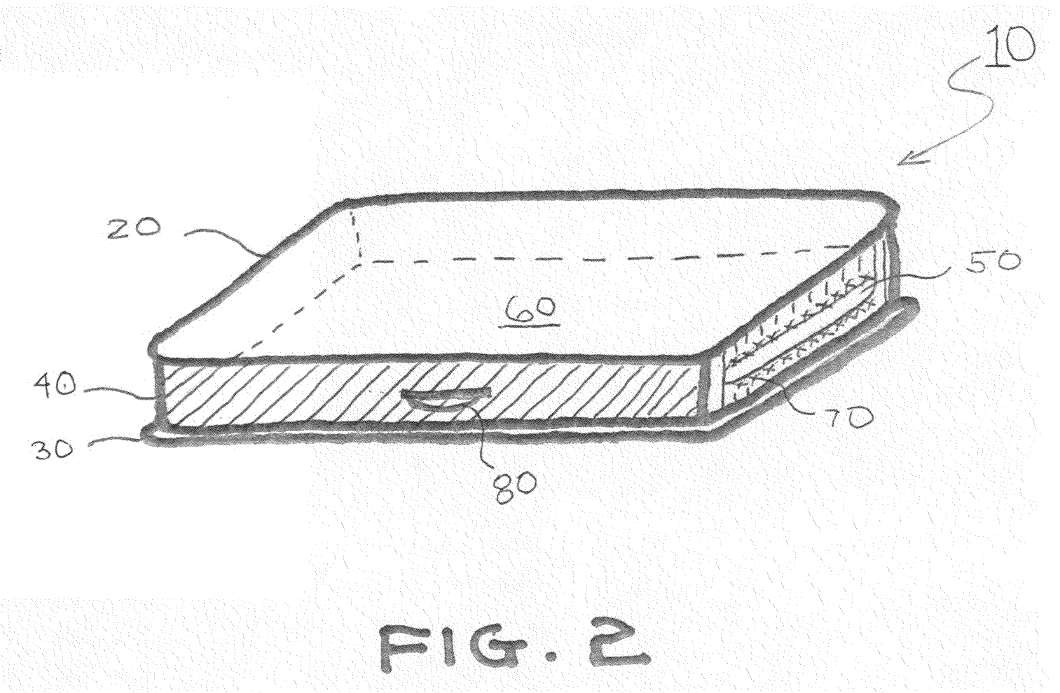

FIG. 2 is a perspective view of a pet bed cover 10, according to the present invention. As previously noted, the pet bed cover comprises a first bed top cover 20, a second bed top cover 30 and at least one side panel 40 affixed about the periphery of the first and second bed top panels. Typically, the side panel(s) will be affixed to the first and second bed top panels by a conventional stitching process or any other means of permanently joining or attaching the bed top panels to the side panel(s) may be employed.

The pet bed cover 10 additionally includes an opening 50 suitable to receive an infant mattress. As shown in FIG. 2, the opening will typically be formed in a widthwise side panel 40. However, in alternate embodiment the opening may be formed in a lengthwise side panel, in one of the bed top panels 20 or 30 or at any of the side panel-to-bed top panel interfaces.

The opening 50 is in communication with a mattress-receiving compartment 60 formed by the interior surfaces of the first and second bed top panel 20 and 30 and the side panel(s) 40. The mattress-receiving compartment is dimensionally configured to receive an infant mattress. In one embodiment of the invention, the mattress-receiving compartment has a length greater than about 52 inches, a width of greater than about 27 inches and a depth of greater than about 6. In one embodiment of the invention, the mattress-receiving compartment has a preferable length in the range of 50 inches to about 60 inches, a preferable width in the range of about 25 inches to about 32 inches and a preferable depth of about 3 inches to about 10 inches. In one specific embodiment, the mattress-receiving compartment has a length in the range of about 52 inches to about 55 inches, a width in the range of about 28 inches to about 30 inches and a depth of about 6 inches to about 8 inches, suitable to house a conventional 5.5 inches thick infant mattress. In another specific embodiment, the mattress compartment has a length in the range of about 52 inches to about 55 inches, a width in the range of about 28 inches to about 30 inches and a depth of about 3 inches to about 5 inches, suitable to house a conventional 2.5 inches thick infant mattress.

Additionally, the opening will typically be configured with an associated enclosure mechanism 70. For example, the enclosure mechanism may be, but is not limited to, a zipper, a hook and loop fabric fastener (such as a Velcro® fastener, available from Velcro USA, Incorporated of Manchester N.H.), a plurality of buttons, a plurality of metallic or plastic snap fasteners or the like. Also, the pet bed cover 10 of the present invention may be configured with a handle 80 operable for carrying the pet bed. As show, the handle 80 may be affixed to the lengthwise portion of the side panel to allow for ease in carrying the pet bed. Alternatively, the handle may be affixed to any other portion of the pet bed cover. The handle may be formed from a fabric or a plastic material.

Thus, the present invention provides for a pet bed cover that allows for an infant mattress to be converted into a pet bed. As such, the present invention is environmentally friendly, in that, the useful life of an infant mattress is extended beyond its intended purpose. The pet bed cover of the present invention also provides for a cost efficient pet bed because the consumer only needs to invest in the inexpensive pet bed cover in order to be afforded a high quality pet bed.

While the foregoing disclosure discusses illustrative aspects and/or embodiments, it should be noted that various changes and modifications could be made herein without departing from the scope of the described aspects and/or embodiments as defined by the appended claims. Furthermore, although elements of the described aspects and/or embodiments may be described or claimed in the singular, the plural is contemplated unless limitation to the singular is explicitly stated. Additionally, all or a portion of any aspect and/or embodiment may be utilized with all or a portion of any other aspect and/or embodiment, unless stated otherwise.

What is claimed is:

1. A pet bed cover; comprising:
a first bed top panel;
a second bed top panel;
at least one side panel affixed about a periphery of the first and second bed top panels;
an opening formed in one of the group consisting of the at least one side panel, the first bed top panel, the second bed top panel and a side panel-to-bed top panel interface; and
a mattress-receiving compartment in communication with the opening and formed by interior surfaces of the first and second bed top panel and the at least one side panel,
wherein the mattress-receiving compartment is dimensionally configured to receive an infant mattress.

2. The pet bed cover of claim 1, wherein the mattress-receiving compartment has a length greater than about 52 inches, a width of greater than about 27 inches and a depth of greater than about 6 so as securely receive an infant mattress.

3. The pet bed cover of claim 1, wherein the mattress-receiving compartment has a length in the range of 50 inches to about 60 inches, a width in the range of about 25 inches to about 32 inches and a depth of about 3 inches to about 10 inches.

4. The pet bed cover of claim 1, wherein the mattress-receiving compartment has a length in the range of about 52 inches to about 55 inches, a width in the range of about 28 inches to about 30 inches and a depth of about 3 inches to about 5 inches.

5. The pet bed cover of claim 1, wherein the mattress-receiving compartment has a length in the range of about 52 inches to about 55 inches, a width in the range of about 28 inches to about 30 inches and a depth of about 6 inches to about 8 inches.

6. The pet bed cover of claim 1, wherein top and first and second bed top panels include an exterior surface formed from a material chosen from the group consisting of a natural fleece, a synthetic fleece, a natural twilled fabric, a synthetic twilled fabric, a natural quilted fabric and a synthetic quilted fabric.

7. The pet bed cover of claim 1, wherein the opening further comprises an enclosure mechanism chosen from the group consisting of a zipper, a hook and loop fabric fastener, a plurality of buttons and a plurality of snap fasteners.

8. The pet bed cover of claim 1, further comprising a handle affixed to the at least one side pine operable for carrying the pet bed.
